(19) United States
(12) Patent Application Publication
(10) Pub. No.: US 2015/0280991 A1
(43) Pub. Date: Oct. 1, 2015

(54) METHOD AND DEVICE FOR MANAGING AND CONFIGURING FIELD DEVICES IN AN AUTOMATION INSTALLATION (I)

(71) Applicant: ABB TECHNOLOGY AG, Zurich (CZ)

(72) Inventors: Dirk WAGENER, Stadthagen (DE); Christoph WELTE, Neu-Ulm (DE); Marcus HEEGE, Kaisersesch (DE); Wolfgang MAHNKE, Hettenleidelheim (DE); Marko SCHLUTER, Espelkamp (DE)

(73) Assignee: ABB TECHNOLOGY AG, Zurich (CZ)

(21) Appl. No.: 14/671,631

(22) Filed: Mar. 27, 2015

(30) Foreign Application Priority Data
Mar. 28, 2014 (DE) 102014004478.5

(51) Int. Cl. H04L 12/24; G06F 3/0482; G06F 3/0483; G06F 3/0484

(52) U.S. Cl. CPC H04L 41/0853; H04L 41/22; G06F 3/04842; G06F 3/0482; G06F 3/0483

(57) ABSTRACT

An exemplary method and device provide for managing and configuring field devices in an automation installation with a configuration tool designed to physically detect a field device in the automation installation, logically incorporate the field device in the automation installation, and configure the field device in the automation installation. For this purpose, the configuration tool uses a predefined field-device-specific information packet which describes the functions and data of the field device. The functions and data of the field device are displayed in an instantiated manner in windows or dialogs on a display. In order to improve clarity, the display groups windows of the same device entity for the same input context and displays them in a superordinate group window.

### RELATED APPLICATION(S)

This application claims priority under 35 U.S.C. §119 to German application 102014004478.5 filed on Mar. 28, 2014, the entire content of which is hereby incorporated by reference.

### FIELD

The disclosure relates to a method and a device for managing and configuring field devices in an automation installation. The disclosure is germane to process automation or machine control for controlling processes and/or installation components.

### BACKGROUND INFORMATION

Automation systems for controlling a technical process or a technical installation usually include a control device (PLC) which is integrated in a group of a multiplicity of intelligent electrical devices. Intelligent Electronic Devices (IEDs) are microprocessor-based devices, for example protective and control devices, motor protective devices, intelligent switches and voltage regulators, frequency converters, pressure and temperature measuring transducers, flowmeters, and actuators.

The article “FDI Device Integration—Best of Both Worlds”, atp edition 6/2010, pages 16 to 19, discloses the practice of integrating field devices in an automation installation using the FDI concept (Field Device Integration IEC-62769). The basis of this concept is the provision of information for configuring field devices in a device-specific FDI packet. This FDI packet includes a firmly predefined amount of information which includes of a device definition, business logic, a user interface description and user interface plug-ins. The device definition includes management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices using EDD (electronic device description) technology IEC 61804, a device manufacturer provides an EDD which includes information relating to the communication with the device, the business logic and the user interfaces, which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets can be created by device manufacturers and are used by system manufacturers to integrate and configure the devices from the device manufacturers in their system.

In addition to an individual user element having different parameters, graphs and other elements, new windows and dialogs may also be defined in the EDD. In this case, a host can have certain freedoms and can display a plurality of menus defined in the EDD in different windows at the same time, for example, or else user interfaces of different device entities.

Known EDD host systems either restrict the number of windows or open an arbitrary number of windows for the different devices. In this case, the overview of the assignment of the windows to the devices is lost.

In addition, the EDD specification defines an input context including changes to a device configuration which have already been made by the user at the interface but have not yet been written to the device or the offline configuration by the user. According to the specification, it is possible in this case for different windows and dialogs to work on different input contexts of the same device. This concept makes it even more difficult for a user to assign the windows not only to the device but also to a particular input context.

According to known implementations, EDD host systems display the windows described in the EDD as windows of the application, with the result that the user can compare a plurality of window contents with one another. However, it can be difficult to assign the windows to a specified device entity and even more difficult to assign a specified input context of this device entity. If a user wishes to use or reject an input context, it can be difficult to discern which windows are affected thereby.

### SUMMARY

An exemplary method for managing and configuring field devices in an automation installation with a configuration tool is disclosed, the configuration tool is configured to physically detect a field device in the automation installation, logically incorporate the field device in the automation installation, and configure the field device in the automation installation using a predefined field-device-specific information packet which describes functions and data of the field device, the method comprising: displaying the functions and data of the field device in an instantiated manner using input windows or dialogs on a display means, grouping, in a processor of the configuration tool, the input windows of a same device entity and for a same input context; and displaying the grouped input windows in a superordinate group window.

A device for managing and configuring field devices in an automation installation is disclosed, comprising: a processor configured to execute a configuration tool that physically detects a field device in the automation installation, logically incorporates the field device in the automation installation, and configures the field device in the automation installation using a predefined field-device-specific information packet which describes the functions and data of the field device; and display means for displaying the functions and data of the field device in an instantiated manner in input windows or dialogs, the display means being configured to visualize a plurality of identical group windows having both operating elements for each group window and the input windows of a same device entity for a same input context.

### BRIEF DESCRIPTION OF THE DRAWINGS

The disclosure is explained in more detail below using exemplary embodiments. In the drawings:

FIG. 1 shows a basic illustration of grouped input windows of a device entity in a configuration tool in accordance with an exemplary embodiment of the present disclosure;

FIG. 2 shows a basic illustration of input windows of a duplicated device entity in a configuration tool in accordance with an exemplary embodiment of the present disclosure;

FIG. 3 shows a basic illustration of group windows of different input windows of the same device entity in accordance with an exemplary embodiment of the present disclosure; and

FIG. 4 shows a flowchart of a method for managing and configuring field devices in an automation installation in accordance with an exemplary embodiment of the present disclosure.

### DETAILED DESCRIPTION

Exemplary embodiments of the present disclosure provide for the management and configuration of field devices in an automation installation with a configuration tool.

Exemplary embodiments of the present disclosure are based on management and configuration of field devices in an automation installation with a configuration tool which is designed to physically detect a field device in the automation installation, to logically incorporate the field device in the automation installation and to configure the field device in the automation installation. For this purpose, the configuration tool uses a predefined field-device-specific information packet which describes the functions and data of the field device and is displayed in an instantiated manner in windows or dialogs on a display means (e.g., monitor, display screen, or other suitable display device as desired).

An exemplary method of the present disclosure provides for the input windows of the same device entity and for the same input context to be grouped and to be displayed in a superordinate group window.

An exemplary device of the present disclosure provides for the display means of the configuration tool to be designed to visualize a plurality of identical group windows including both the operating elements for the group window and the input windows of the same device entity for the same input context.

As a result, the windows can be clearly assigned to the device entities and input contexts for the user.

According to another exemplary embodiment of the disclosure, the input windows for the same input contexts of the same device entity are grouped according to a condition in which the input windows are congruently placed on top of one another and can be selected using individual selection operating elements. In this case, the selection operating elements for the different input windows are equally provided in all input windows of the same device entity. Actuation of one of the selection operating elements brings the associated input window of the same device entity into the foreground for operation and this overlies all other input windows of the same device entity in a covering manner.

According to yet another exemplary embodiment of the present disclosure, the selection operating elements can be in the form of tabs. Actuation of a tab results in a changeover to the associated input window of the same device entity.

In addition, uniform operating elements for applying or rejecting the changes in the input context can be provided in the input windows independently of the device entity.

According to an exemplary embodiment of the present disclosure, the group window of a device entity can be duplicated, if necessary. The duplicate being designed in such a manner that all device-related operations on the original or the duplicate have an identical effect on the original and the duplicate. These include, for example, operations of writing to the device.

The duplicated display of the same device entity allows comparisons of different input windows for an input context of the same device entity in a clear display. In this case, operations are avoided by alternately switching back and forth between the displays inside the same device entity.

According to still another exemplary embodiment of the present disclosure, the input windows of the same device entity are grouped by virtue of the fact that the input windows of a device entity within an input context are displayed in a freely positionable manner in a group window which forms a frame around the input windows of the same device entity. These group windows can be enlarged, reduced, shifted and closed using known window management mechanisms. The input windows inside the group window can also be enlarged, reduced, shifted and closed using the known window management mechanisms.

According to yet another exemplary embodiment of the present disclosure, uniform operating elements for applying or rejecting the changes in the input context are provided in the input windows independently of the device entity.

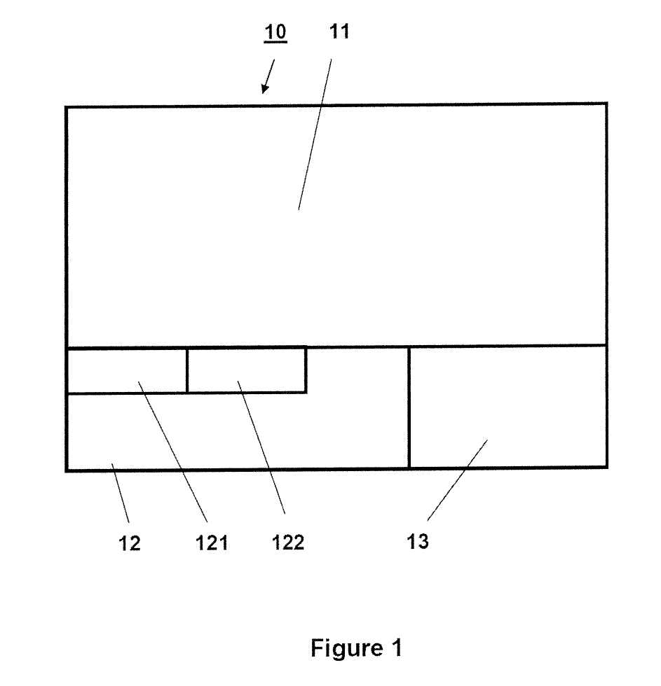

FIG. 1 shows a basic illustration of grouped input windows of a device entity in a configuration tool in accordance with an exemplary embodiment of the present disclosure. As shown in FIG. 1, the group window 10 can have at least one input window 11 for an EDD-based user interface which is designed to visualize user interactions relating to an input context of a device entity. The group window 10 also can have a selection menu 12 including at least one selection operating element 121, 122.

In order to clearly visualize a plurality of input windows 11 of the same device entity, each selection operating element 121, 122 is assigned precisely one input window 11 of the device entity, which input window is displayed in the group window 10 during actuation of the respective selection operating element 121, 122. Depending on the selection operating element 121, 122 selected, the input window 11 shows another user interface of the same device entity.

The group window 10 also can have a uniform operating panel 13 for applying or rejecting the changes to the respective user interface.

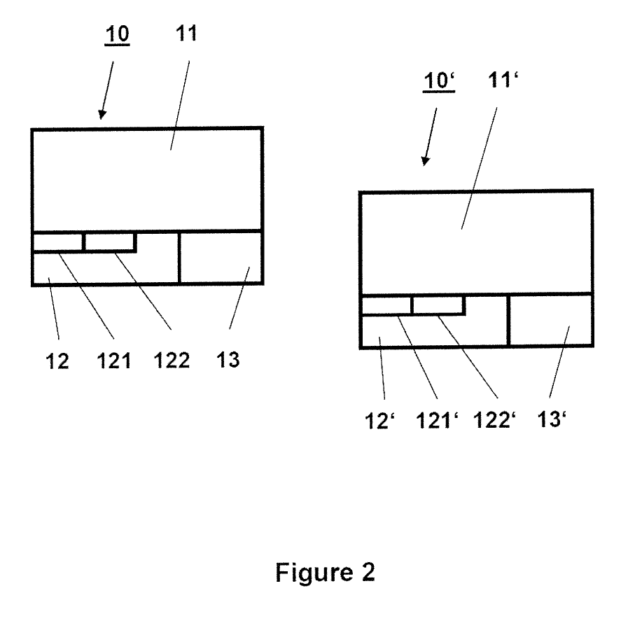

FIG. 2 shows a basic illustration of input windows of a duplicated device entity in a configuration tool in accordance with an exemplary embodiment of the present disclosure. For example, FIG. 2 illustrates a first group window 10 for a device entity and a second, identical group window 10′ for a duplicate of the same device entity.

The first group window 10 can have an input window 11 for an EDD-based user interface, a selection menu 12 and an operating panel 13. In the same manner, the second group window 10′ can have an input window 11′ for an EDD-based user interface, a selection menu 12′ and an operating panel 13′. Both group windows 10 and 10′ show input windows 11 and 11′ of the same device entity but identical or different user interfaces depending on the input windows 11 and 11′ selected in the selection menus 12 and 12′.

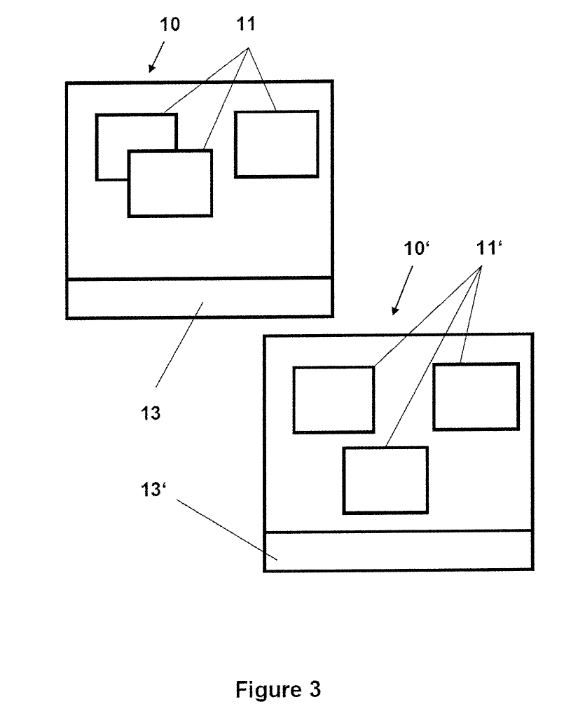

FIG. 3 shows a basic illustration of group windows of different input windows of the same device entity in accordance with an exemplary embodiment of the present disclosure. For example, FIG. 3 illustrates a first group window 10 and a second group window 10′. In this case, the first group window 10 includes a plurality of input windows 11 of all user interfaces of the same device entity and an operating panel 13. The second group window 10′ includes a plurality of input windows 11 of all user interfaces of the same but a different device entity and an operating panel 13.

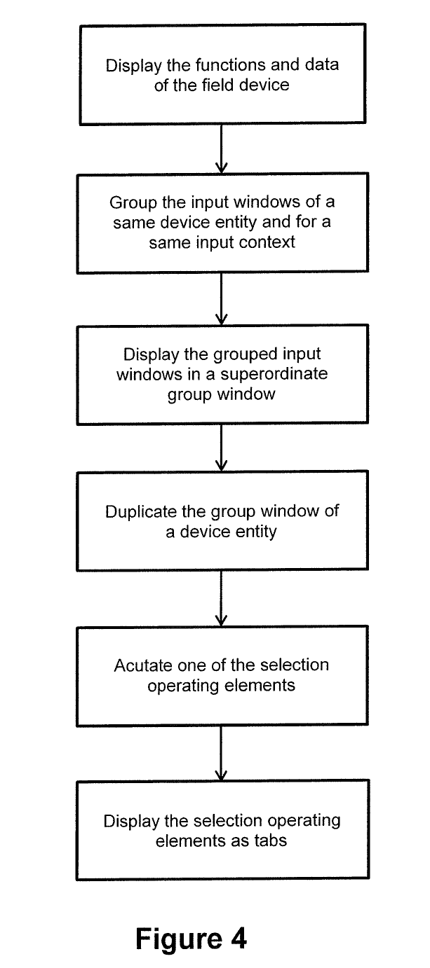

FIG. 4 shows a flowchart of a method for managing and configuring field devices in an automation installation in accordance with an exemplary embodiment of the present disclosure. As already discussed, the configuration tool is configured to physically detect a field device in the automation installation, logically incorporate the field device in the automation installation, and configure the field device in the automation installation using a predefined field-device-specific information packet which describes functions and data of the field device. The method includes the steps of displaying the functions and data of the field device in an instantiated manner using input windows or dialogs on a display means. Grouping, in a processor of the configuration tool, the input windows of a same device entity and for a same input context, and displaying the grouped input windows in a superordinate group window. The group window of a device entity can be duplicated, wherein the duplicate group window has all device-related operations of a same device entity of an original group window or the duplicate group window has all device-related operations of a different device entity from the original group window. The input windows of the same device entity can be congruently placed on top of one another and are selected using individual selection operating elements. One of the selection operating elements can be actuated to bring an associated input window of the same device entity into a foreground for operation such that the associated input window overlays all other input windows of the same device entity in a covering manner. The selection operating elements can be displayed as tabs and/or can be displayed for the different input windows equally in all input windows of the same device entity.

According to exemplary embodiments of the present disclosure the configuration tool can be implemented in software and/or hardware including one or more of any known general purpose processor or integrated circuit such as a central processing unit (CPU), microprocessor, field programmable gate array (FPGA), Application Specific Integrated Circuit (ASIC), or other suitable programmable processing or computing devices or circuits as desired having an associated and suitable display monitor or display device. The general processor(s) can be configured to include and perform features of the exemplary embodiments of the present disclosure such as, a method for managing and configuring field devices in an automation installation, and thereby function as a special and unique processor. The features can be performed through program code encoded or recorded on the processor(s), or stored in a non-volatile memory device, such as Read-Only Memory (ROM), erasable programmable read-only memory (EPROM), or other suitable memory device or circuit as desired. In another exemplary embodiment, the program code can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10, 10′ Group window
11, 11′ Input window
12, 12′ Selection menu
121, 121′, 122, 122′ Selection operating element
13, 13′ Operating panel

What is claimed is:

1. A method for managing and configuring field devices in an automation installation with a configuration tool configured to physically detect a field device in the automation installation, logically incorporate the field device in the automation installation, and configure the field device in the automation installation using a predefined field-device-specific information packet which describes functions and data of the field device, the method comprising:
displaying the functions and data of the field device in an instantiated manner using input windows or dialogs on a display means,
grouping, in a processor of the configuration tool, the input windows of a same device entity and for a same input context; and
displaying the grouped input windows in a superordinate group window.

2. The method as claimed in claim 1, comprising:
duplicating the group window of a device entity, wherein the duplicate group window having all device-related operations of a same device entity of an original group window or the duplicate group window having all device-related operations of a different device entity from the original group window.

3. The method as claimed in claim 1, wherein the input windows of the same device entity are congruently placed on top of one another and are selected using individual selection operating elements.

4. The method as claimed in claim 3, comprising:
acutating one of the selection operating elements to bring an associated input window of the same device entity into a foreground for operation such that the associated input window overlays all other input windows of the same device entity in a covering manner.

5. The method as claimed in claim 3, comprising:
displaying the selection operating elements as tabs.

6. The method as claimed in claim 3, comprising:
duplicating the group window of a device entity, wherein the duplicate group window having all device-related operations of a same device entity of an original group window or the duplicate group window having all device-related operations of a different device entity from the original group window.

7. The method as claimed in claim 6, comprising:
displaying the selection operating elements for the different input windows equally in all input windows of the same device entity.

8. The method as claimed in claim 6, comprising:
displaying the selection operating elements as tabs.

9. The method as claimed in claim 6, comprising:
duplicating the group window of a device entity, wherein the duplicate group window having all device-related operations of a same device entity of an original group window or the duplicate group window having all device-related operations of a different device entity from the original group window.

10. The method as claimed in claim 6, comprising:
acutating one of the selection operating elements to bring an associated input window of the same device entity into a foreground for operation such that the associated input window overlays all other input windows of the same device entity in a covering manner.

11. The method as claimed in claim 10, wherein the selection operating elements are displayed as tabs.

12. The method as claimed in claim 10, comprising:
duplicating the group window of a device entity, wherein the duplicate group window having all device-related operations of a same device entity of an original group window or the duplicate group window having all device-related operations of a different device entity from the original group window.

13. The method as claimed in claim 1, comprising:
displaying the input windows of the same device entity in a freely positionable manner in a group window, which forms a frame around the input windows of the same device entity.

14. The method as claimed in claim 13, comprising:
assigning uniform operating elements for applying or rejecting changes in an input context to the input windows independently of the device entity.

15. A device for managing and configuring field devices in an automation installation, comprising:
a processor configured to execute a configuration tool that physically detects a field device in the automation installation, logically incorporates the field device in the automation installation, and configures the field device in the automation installation using a predefined field-device-specific information packet which describes the functions and data of the field device; and
display means for displaying the functions and data of the field device in an instantiated manner in input windows or dialogs, the display means being configured to visualize a plurality of identical group windows having both operating elements for each group window and the input windows of a same device entity for a same input context.

16. The device as claimed in claim 15, wherein the display means displays the operating elements in the form of tabs.
